(19) United States
(12) Patent Application Publication
(10) Pub. No.: US 2026/0247470 A1
(43) Pub. Date: Aug. 20, 2026

(54) SUSTAINING LOCAL RADIO NETWORK OPERATIONS DURING ISOLATION FROM A CORE NETWORK

(71) Applicant: VIAVI Solutions Inc., Chandler, AZ (US)

(72) Inventors: James Gordon BEATTIE, JR., Live Oak, FL (US); Howard John THOMAS, Stonehouse (GB)

(21) Appl. No.: 19/054,439

(22) Filed: Feb. 14, 2025

(51) Int. Cl. H04W 76/25; H04W 8/10; H04W 24/08

(52) U.S. Cl. CPC H04W 76/25; H04W 8/10; H04W 24/08

(57) ABSTRACT

A device may receive data to maintain a core network service upon disconnection of a radio access network (RAN) from a core network, and may receive data to maintain connectivity with adjacent RANs upon disconnection of the RAN from the core network. The device may receive data to support service continuity across the adjacent RANs upon disconnection of the RAN from the core network, and may monitor core data associated with the RAN. The device may identify a disconnection of the RAN from the core network based on monitoring the core data, and may control the RAN upon the disconnection of the RAN from the core network based on the data to maintain the core network service, the data to maintain the connectivity with the adjacent RANs, and the data to support the service continuity across the adjacent RANs. The device may store the core data.

### BACKGROUND

A cellular site provided by a radio access network (RAN) may connect to a core network that provides services to the RAN and to user equipments (UEs) associated with the RAN.

### SUMMARY

Some implementations described herein relate to a method. The method may include receiving data to maintain a core network service upon disconnection of a RAN from a core network, and receiving data to maintain connectivity with adjacent RANs upon disconnection of the RAN from the core network. The method may include receiving data to support service continuity across the adjacent RANs upon disconnection of the RAN from the core network, and monitoring core data associated with the RAN. The method may include identifying a disconnection of the RAN from the core network based on monitoring the core data, and controlling the RAN upon the disconnection of the RAN from the core network based on the data to maintain the core network service, the data to maintain the connectivity with the adjacent RANs, and the data to support the service continuity across the adjacent RANs. The method may include storing the core data.

Some implementations described herein relate to a device. The device may include one or more memories and one or more processors coupled to the one or more memories. The one or more processors may be configured to receive data to maintain a core network service upon disconnection of a RAN from a core network, and receive data to maintain connectivity with adjacent RANs upon disconnection of the RAN from the core network. The one or more processors may be configured to receive data to support service continuity across the adjacent RANs upon disconnection of the RAN from the core network, and monitor core data associated with the RAN. The one or more processors may be configured to identify a disconnection of the RAN from the core network based on monitoring the core data, and control the RAN upon the disconnection of the RAN from the core network based on the data to maintain the core network service, the data to maintain the connectivity with the adjacent RANs, and the data to support the service continuity across the adjacent RANs. The one or more processors may be configured to store the core data, and provide the stored core data to the core network when a connection between the RAN and the core network is restored.

Some implementations described herein relate to a non-transitory computer-readable medium that stores a set of instructions. The set of instructions, when executed by one or more processors of a device, may cause the device to receive data to maintain a core network service upon disconnection of a RAN from a core network, and receive data to maintain connectivity with adjacent RANs upon disconnection of the RAN from the core network. The set of instructions, when executed by one or more processors of the device, may cause the device to receive data to support service continuity across the adjacent RANs upon disconnection of the RAN from the core network, and monitor core data associated with the RAN. The set of instructions, when executed by one or more processors of the device, may cause the device to identify a disconnection of the RAN from the core network based on monitoring the core data, and control the RAN upon the disconnection of the RAN from the core network based on the data to maintain the core network service, the data to maintain the connectivity with the adjacent RANs, and the data to support the service continuity across the adjacent RANs. The set of instructions, when executed by one or more processors of the device, may cause the device to store the core data, and exchange user equipment data with another device associated with an adjacent RAN.

### BRIEF DESCRIPTION OF THE DRAWINGS

FIGS. 1A-1H are diagrams of an example associated with sustaining local radio network operations during isolation from a core network.

FIG. 2 is a diagram of an example environment in which systems and/or methods described herein may be implemented.

FIG. 3 is a diagram of example components of one or more devices of FIG. 2.

FIG. 4 is a flowchart of an example process for sustaining local radio network operations during isolation from a core network.

### DETAILED DESCRIPTION

The following detailed description of example implementations refers to the accompanying drawings. The same reference numbers in different drawings may identify the same or similar elements.

A RAN may become disconnected and isolated from a core network at times. When the RAN becomes disconnected from the core network, several significant problems arise that impact both the RAN's operations and operations of UEs associated with the RAN. During isolation from the core network, the RAN is unable to provide core network services to UEs connected to the RAN. This means that essential services such as voice calls, text messaging, Internet access, and other data services are disrupted. Without a connection to the core network, the RAN may fail to maintain continuity of service, which can lead to dropped calls, interrupted data sessions, and an overall degradation of service quality for UEs. Moreover, the core network plays a crucial role in managing and controlling the RAN, including tasks such as resource allocation, handovers, and mobility management. Disconnection from the core network means that the RAN loses access to those management functions, potentially leading to inefficiencies and issues in network performance. The RAN may have difficulty maintaining connectivity with adjacent RANs, which can affect handovers of UEs moving between different RANs. The disconnection from the core network may lead to potential security vulnerabilities, where the RAN may be more susceptible to security threats and attacks. Therefore, current techniques for handling disconnection of a RAN from a core network consume computing resources (e.g., processing resources, memory resources, communication resources, and/or the like), networking resources, and/or the like associated with failing to provide core network services, failing to maintain continuity of service, losing management functions that lead to inefficiencies and issues in network performance, failing to maintain connectivity with adjacent RANs, handling security vulnerabilities, and/or the like.

Some implementations described herein relate to sustaining local radio network operations during isolation from a core network. For example, a device associated with a RAN may receive data to maintain a core network service upon disconnection of the RAN from a core network, and may receive data to maintain connectivity with adjacent RANs upon disconnection of the RAN from the core network. The device may receive data to support service continuity across the adjacent RANs upon disconnection of the RAN from the core network, and may monitor core data associated with the RAN. The device may identify a disconnection of the RAN from the core network based on monitoring the core data, and may control the RAN upon the disconnection of the RAN from the core network based on the data to maintain the core network service, the data to maintain the connectivity with the adjacent RANs, and the data to support the service continuity across the adjacent RANs. The device may store the core data.

In this way, local radio network operations are sustained during isolation from a core network. For example, a RAN may be equipped with a local edge computing device that provides RAN services at the RAN. The edge computing device may perform a distribution unit (DU) function and a control unit (CU) function on a contingency basis. The RAN may also be equipped with a local edge computing device that provides network core services on a contingency basis at the RAN in conjunction with the local edge computing device that provides the RAN services. Thus, the RAN conserves computing resources, networking resources, and/or the like that would otherwise have been lost by failing to provide core network services, failing to maintain continuity of service, losing management functions that lead to inefficiencies and issues in network performance, failing to maintain connectivity with adjacent RANs, handling security vulnerabilities, and/or the like.

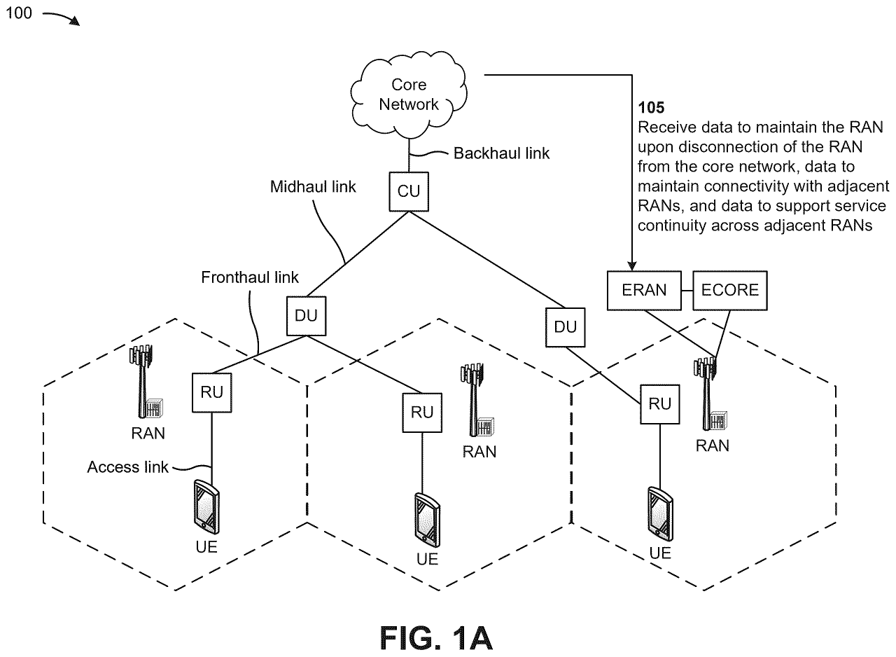

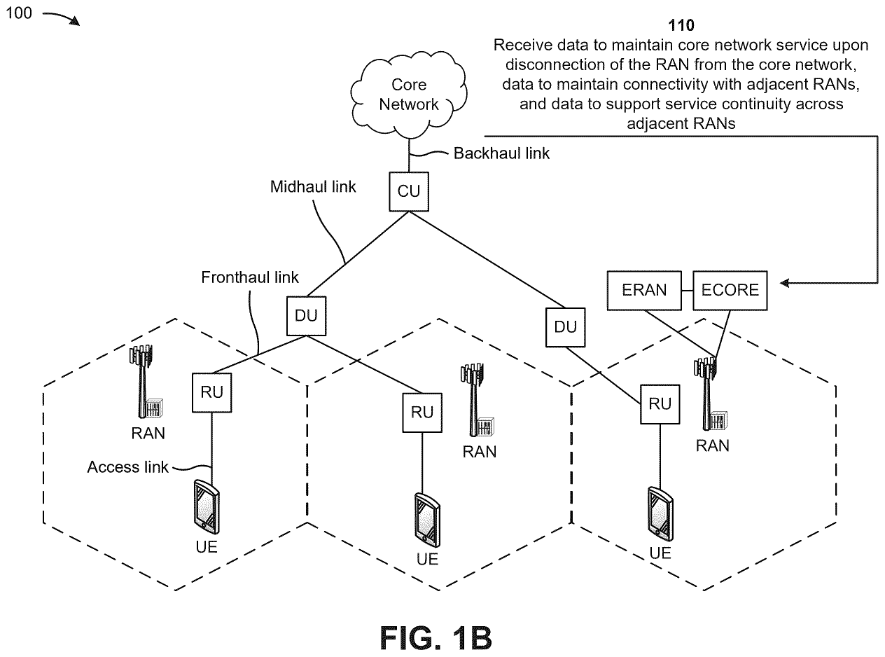

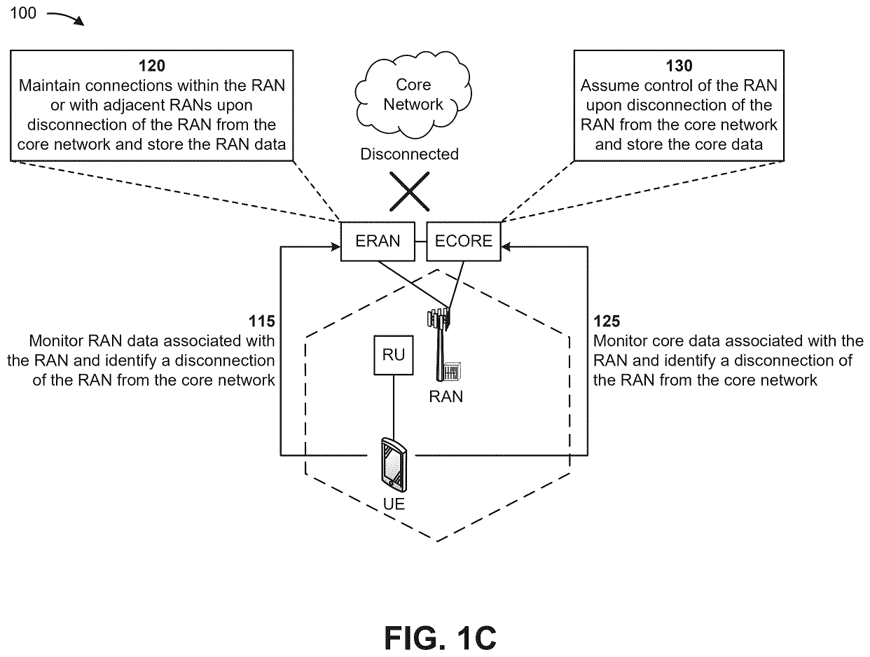

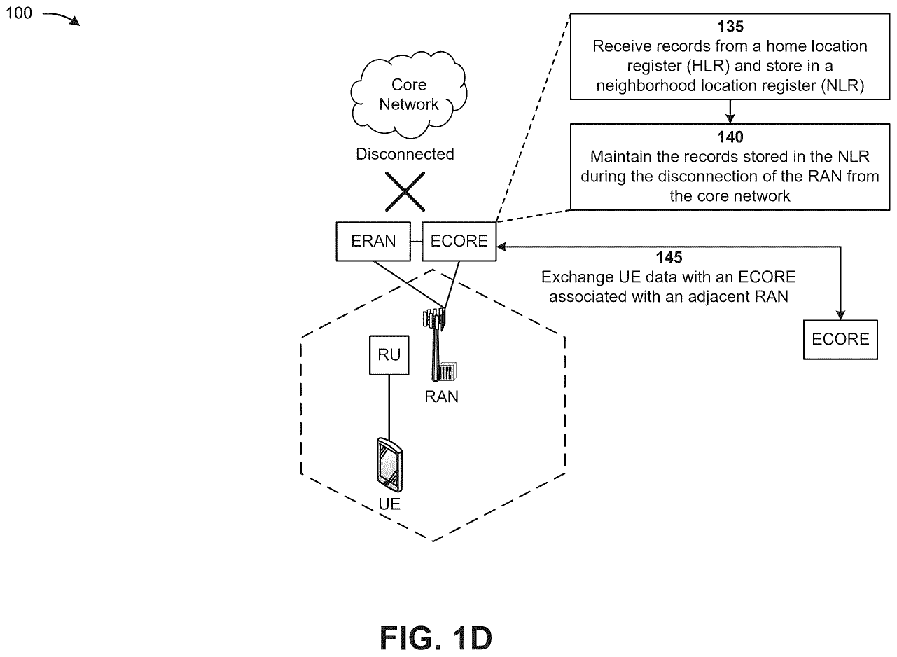

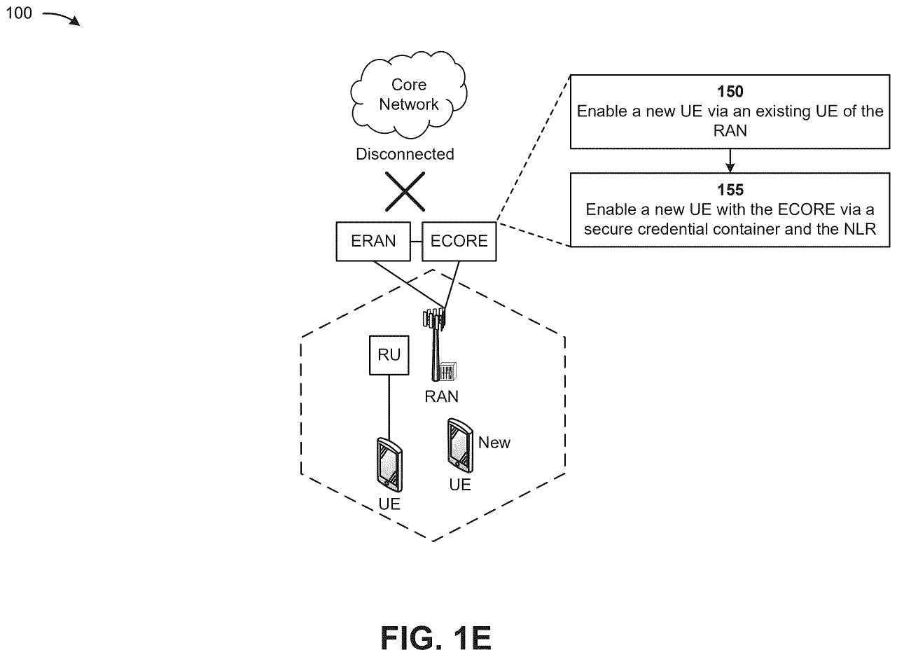

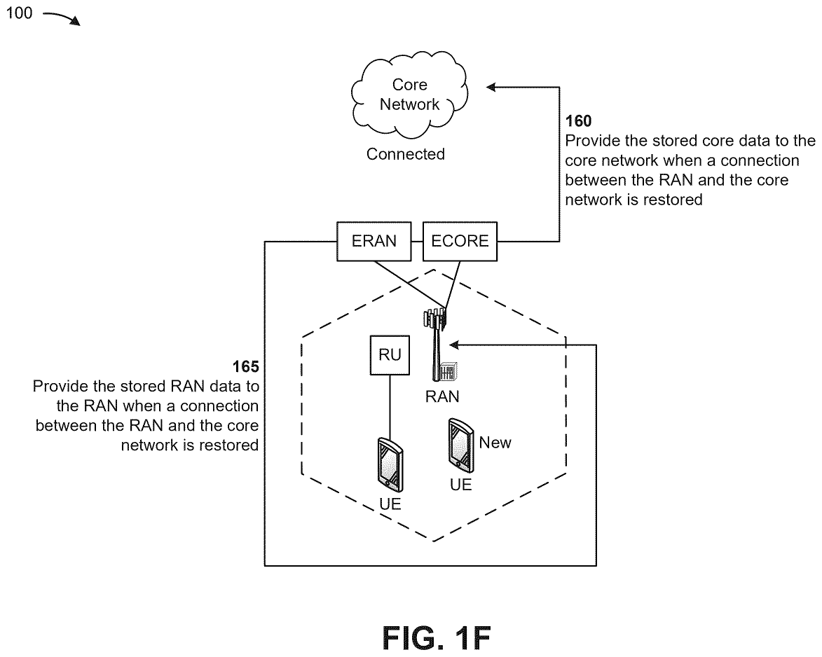

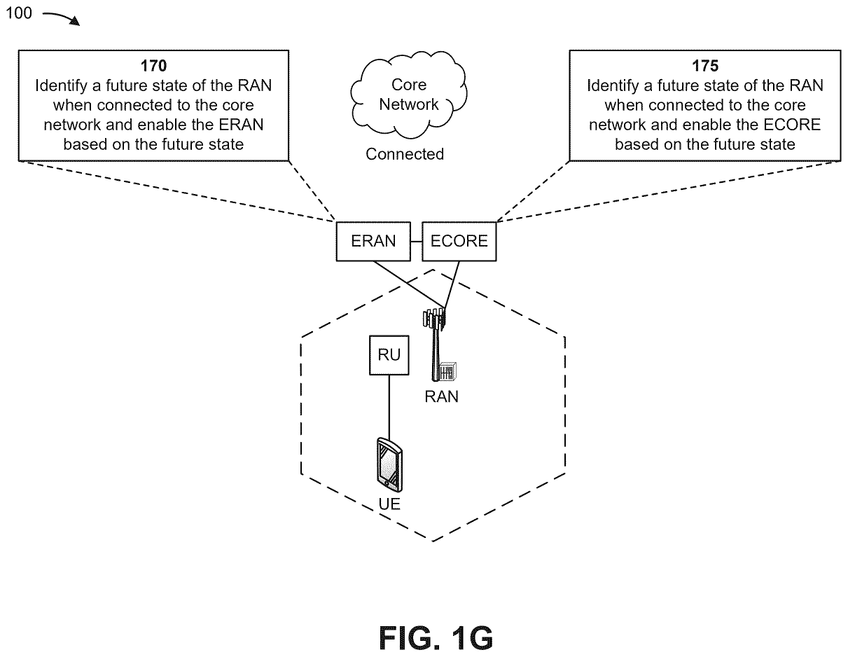

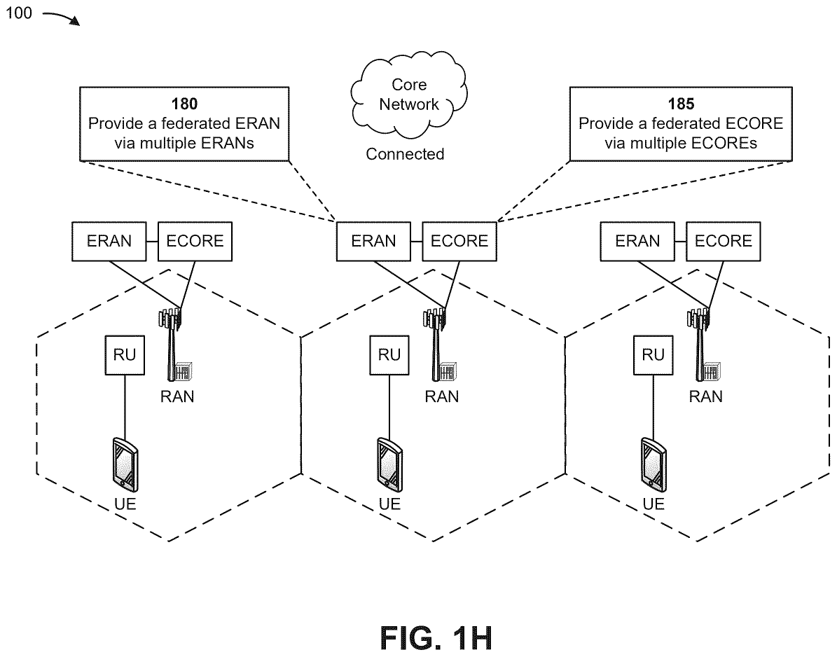

FIGS. 1A-1H are diagrams of an example 100 associated with sustaining local radio network operations during isolation from a core network. As shown in FIGS. 1A-1H, the example 100 may include UEs associated with RANs and a core network. In some implementations, the RANs may be associated with radio units (RUs), DUs, CUs, an edge RAN (ERAN), and an edge core network (ECORE). Further details of the UEs, the RANs, the core network, the RUs, the DUs, the CUs, the ERANs, and the ECOREs are provided elsewhere herein.

FIG. 1A is a diagram illustrating an example of an open RAN (O-RAN) architecture. As shown in FIG. 1A, the O-RAN architecture may include a CU that communicates with the core network via a backhaul link. Furthermore, the CU may communicate with one or more DUs via respective midhaul links. The DUs may each communicate with one or more RUs via respective fronthaul links, and the RUs may each communicate with respective UEs via radio frequency (RF) access links. The DUs and the RUs may also be referred to as O-RAN DUs (O-DUs) and O-RAN RUs (O-RUs), respectively. In some implementations, the O-DUs may communicate with other O-DUs, an O-RU may communicate with multiple O-DUs, and multiple O-RUs may communicate with each other.

In some implementations, the DUs and the RUs may be implemented according to a functional split architecture in which functionality of the RAN is provided by a DU and one or more RUs that communicate over a fronthaul link. Accordingly, as described herein, a RAN may include a DU and one or more RUs that may be co-located or geographically distributed. In some implementations, the DU and the associated RU(s) may communicate via a fronthaul link to exchange real-time control plane information via a lower layer split (LLS) control plane (LLS-C) interface, to exchange non-real-time management information via an LLS management plane (LLS-M) interface, or to exchange user plane information via an LLS user plane (LLS-U) interface.

Accordingly, the DU may correspond to a logical unit that includes one or more network node functions to control the operation of one or more RUs. For example, in some implementations, the DU may host a radio link control (RLC) layer, a medium access control (MAC) layer, and one or more higher physical (PHY) layers (e.g., forward error correction (FEC) encoding and decoding, scrambling, or modulation and demodulation) based at least in part on a lower layer functional split. Higher layer control functions, such as a packet data convergence protocol (PDCP), radio resource control (RRC), or service data adaptation protocol (SDAP), may be hosted by the CU. The RU(s) controlled by a DU may correspond to logical nodes that host RF processing functions and low-PHY layer functions (e.g., fast Fourier transform (FFT), inverse FFT (iFFT), digital beamforming, or physical random access channel (PRACH) extraction and filtering) based at least in part on the lower layer functional split. Accordingly, in an O-RAN architecture, the RU(s) handle all over the air (OTA) communication with a UE, and real-time and non-real-time implementations of control and user plane communication with the RU(s) are controlled by the corresponding DU, which enables the DU(s) and the CU to be implemented in a cloud-based RAN architecture.

As further shown in FIG. 1A, a RAN may be associated with the ERAN and the ECORE. In some implementations, each of the RANs may be associated with an ERAN and an ECORE. The ERAN may include a local edge computing device that provides RAN services at a RAN site by utilizing a common public radio interface (CPRI) or an evolved CPRI (ECPRI) of each RU, or by utilizing an aggregated network interface of a multisector cell site. The ERAN may perform DU and CU functions on a contingency basis. The ECORE may include a local edge computing device that provides network core services on a contingency basis at the RAN site in conjunction with the ERAN.

As further shown in FIG. 1A, and by reference number 105, the ERAN may receive data to maintain the RAN upon disconnection of the RAN from the core network, data to maintain connectivity with adjacent RANs, and data to support service continuity across the adjacent RANs. For example, the ERAN may receive, from the core network, data to maintain the RAN when the RAN becomes disconnected from the core network. The data to maintain the RAN may include data that enables managing and controlling of the RAN, such as resource allocation, handovers, and mobility management. In some implementations, the ERAN may receive, from the core network, data to maintain connectivity of the RAN with adjacent RANs. The data to maintain connectivity of the RAN with the adjacent RANs may include connectivity configurations for hardwired, microwave, or integrated access and backhaul (IAB) between the RAN and the adjacent RANs. The ERAN may also receive, from the core network, data to support service continuity across the adjacent RANs. In some implementations, the data to support service continuity across the adjacent RANs may include data that enables seamless handover of UEs moving from the RAN to the adjacent RANs and/or UEs moving from an adjacent RAN to the RAN.

As shown in FIG. 1B, and by reference number 110, the ECORE may receive data to maintain core network service upon disconnection of the RAN from the core network, data to maintain connectivity with adjacent RANs, and data to support service continuity across adjacent RANs. For example, the ECORE may receive, from the core network, data to maintain core network service when the RAN becomes disconnected from the core network. The data to maintain the core network service may include data that enables the RAN to provide services, such as voice calls, text messaging, Internet access, applications, and other data services, to UEs connected to the RAN. Such data may include data to support mobility management of UEs in idle mode, including location area (LA), tracking area (TA), connected cell, and/or the like. In some implementations, the ECORE may also receive, from the core network, the data to maintain connectivity with the adjacent RANs and the data to support service continuity across the adjacent RANs, described above in connection with ERAN. In some implementations, the data received by the ECORE may also include data about the which location areas (and tracking areas) that UEs are registered with, to avoid the need to UEs to reattach to the ECORE after transition.

As shown in FIG. 1C, and by reference number 115, the ERAN may monitor RAN data associated with the RAN, and may identify a disconnection of the RAN from the core network. For example, while the RAN is connected to the core network, the ERAN may monitor the RAN data associated with the RAN. The RAN data may include UE connection data, traffic data (e.g., a volume of data being transmitted and received, types of traffic, and quality of service (QoS) metrics, such as latency, jitter, and packet loss), signal quality metrics (e.g., a signal-to-noise ratio (SNR), a received signal strength indicator (RSSI), a reference signal received power (RSRP), and a reference signal received quality (RSRQ)), performance metrics (e.g., cell load and utilization, handover success rates, call drop rates, and throughput), resource allocation data (e.g., allocation of radio resources to different UEs), mobility management data (e.g., information on UE movement and trajectory), configuration data (e.g., frequency bands and carrier aggregation settings), security data (e.g., authentication and encryption status), event logs (e.g., historical logs of significant events, such as handovers, connection attempts, and failures), neighboring cell information, system information broadcasts, radio link control (RLC) data, and/or the like. In some implementations, the ERAN may identify a disconnection of the RAN from the core network based on failing to receive some or all of the RAN data from the RAN, based on receiving degraded RAN data from the RAN, and/or the like.

As further shown in FIG. 1C, and by reference number 120, the ERAN may maintain connections within the RAN or with adjacent RANs upon the disconnection of the RAN from the core network, and may store the RAN data. For example, when the ERAN identifies the disconnection of the RAN from the core network, the ERAN may maintain connections within the RAN (e.g., with UEs) or with one or more adjacent RANs (e.g., that become disconnected from the core network). In some implementations, the ERAN may utilize the RAN data to maintain the connections within the RAN or with the adjacent RANs when the RAN disconnects from the core network. In some implementations, when the ERAN identifies the disconnection of the RAN from the core network, the ERAN may store the RAN data in a data structure (e.g., database, a table, a list, and/or the like) associated with the ERAN.

As further shown in FIG. 1C, and by reference number 125, the ECORE may monitor core data associated with the RAN, and may identify a disconnection of the RAN from the core network. For example, while the RAN is connected to the core network, the ECORE may monitor the core data associated with the RAN. The core data may include subscriber information (e.g., user profiles, authentication and authorization data, and home location register (HLR) or home subscriber server (HSS) records), session management data (e.g., information related to active sessions, QoS parameters and policies, and session initiation protocol (SIP) messages), mobility management data (e.g., location information of UEs, and handover data for seamless connectivity when UEs move between cells or networks), traffic data (e.g., a volume of data being transmitted and received, types of traffic, and QoS metrics, such as latency, jitter, and packet loss), performance metrics (e.g., cell load and utilization, handover success rates, call drop rates, and throughput), resource allocation data (e.g., allocation of radio resources to different UEs), mobility management data (e.g., information on UE movement, trajectory, TA, and LA that help manage mobility while the UE is in idle mode), security data (e.g., authentication and encryption status), configuration data (e.g., frequency bands and carrier aggregation settings), event logs (e.g., historical logs of significant events, such as handovers, connection attempts, and failures), neighboring cell information, system information broadcasts, RLC data, and/or the like. In some implementations, the ECORE may identify a disconnection of the RAN from the core network based on failing to receive some or all of the core data from the core network, based on receiving degraded core data from the core network, and/or the like.

As further shown in FIG. 1C, and by reference number 130, the ECORE may assume control of the RAN upon the disconnection of the RAN from the core network, and may store the core data. For example, when the ECORE identifies the disconnection of the RAN from the core network, the ECORE may assume control of the RAN. In some implementations, the ECORE may utilize the core data to assume control of the RAN when the RAN disconnects from the core network. In some implementations, when the ECORE identifies the disconnection of the RAN from the core network, the ECORE may store the core data in a data structure (e.g., database, a table, a list, and/or the like) associated with the ECORE.

As shown in FIG. 1D, and by reference number 135, the ECORE may receive records from a home location register (HLR), and may store the records in a neighborhood location register (NLR). For example, the ECORE may include a data structure referred to as an NLR. The functionality of the NLR may be similar to the functionality of a visitor location register (VLR) used to support UEs operating outside of a home location when supported by the HLR. The ECORE may receive records from the HLR, such as records associated with UEs directly operating within the RAN or within a cluster of RANs. The ECORE may store the records in the NLR.

As further shown in FIG. 1D, and by reference number 140, the ECORE may maintain the records stored in the NLR during the disconnection of the RAN from the core network. For example, during the disconnection of the RAN from the core network, the ECORE may maintain and not expire records from the NLR. However, in some implementations, the ECORE may remove records from the NLR when the NLR has limited available storage and/or storage is needed by the ECORE to maintain self-sustained operations of the ECORE.

As further shown in FIG. 1D, and by reference number 145, the ECORE may exchange UE data with an ECORE associated with an adjacent RAN. For example, during the disconnection of the RAN from the core network, the ECORE may exchange active UE data with an ECORE associated with an adjacent RAN. In this way, the ECORE may extend the coverage of an isolated RAN across multiple adjacent RANs, and may form a virtualized, federated, but disaggregated ECORE for the RAN and the adjacent RANs.

As shown in FIG. 1E, and by reference number 150, the ECORE may enable a new UE via an existing UE of the RAN. For example, during the disconnection of the RAN from the core network, new UEs may attempt to attach to the RAN. In some implementations, the ECORE may support the new UEs in a manner similar to that by which off-network emergency calls are supported. For example, the ECORE may enable the new UEs by calling the new UEs from an existing connected UE of the RAN (e.g., identified in the NLR). The new UEs may receive voice calls, data, text calls, applications, and/or the like via the existing UE of the RAN.

As further shown in FIG. 1E, and by reference number 155, the ECORE may enable a new UE with the ECORE via a secure credential container and the NLR. For example, the ECORE may provision a new UE in advance with a secure credential container that may be unlocked through use of a passcode. Once provisioned, the new UE may become a local UE of the ECORE and the RAN and may be enabled in the NLR of the ECORE. Furthermore, the new UE may receive a data call from an existing local UE with a secure credential container. The secure credential container may be saved by the new UE and, through the use of a passcode, the new UE may be enabled in the NLR and become a local UE of the ECORE and the RAN.

As shown in FIG. 1F, and by reference number 160, the ECORE may provide the stored core data to the core network when a connection between the RAN and the core network is restored. For example, the ECORE may determine that a connection between the RAN and the core network is restored based on receiving the core data, based on receiving core data that is not degraded, and/or the like. When the ECORE determines that the connection between the RAN and the core network is restored, the ECORE may provide the stored core data to the core network. In this way, the core network receives the original core data stored by the ECORE and any core data generated by the ECORE during the disconnection of the RAN from the core network. The core network may utilize the core data to provision the RAN and UEs associated with the RAN.

As further shown in FIG. 1F, and by reference number 165, the ERAN may provide the stored RAN data to the RAN when a connection between the RAN and the core network is restored. For example, the ERAN may determine that a connection between the RAN and the core network is restored based on receiving the RAN data, based on receiving RAN data that is not degraded, and/or the like. When the ERAN determines that the connection between the RAN and the core network is restored, the ERAN may provide the stored RAN data to the core network. In this way, the core network receives the original RAN data stored by the ERAN and any RAN data generated by the ERAN during the disconnection of the RAN from the core network. The core network may utilize the RAN data to provision the RAN and UEs associated with the RAN.

When the connection between the RAN and the core network is restored, management and UE traffic may be prioritized and the ECORE and the ERAN may be gradually restored to background operation. The core data stored in the ECORE and the RAN data stored in the ERAN may be uploaded to the core network and the RAN to ensure completeness of historical traffic during the isolation of the RAN from the core network. When there is limited restored connectivity with the core network, network management rules may provide priority UE traffic first to the core network and the RAN. Then operations, administration, and maintenance traffic (e.g., HLR and VLR traffic) may be provided next to the core network and the RAN.

During the connectivity restoration process, a UE may be identified as being authorized to use the isolated RAN when either the UE should not have been authorized or the UE is not a customer of the RAN. When the UE should not have been authorized to utilize the isolated RAN, a source of the secure credential container may be passed to network security for further investigation. When the UE is not a customer of the RAN, the secure credential container may be passed to network billing for intercarrier billing usage for roaming activity or simply dropped per network restoration policy.

As shown in FIG. 1G, and by reference number 170, the ERAN may identify a future state of the RAN when connected to the core network, and may enable the ERAN based on the future state. For example, the ERAN may identify a future state where a load on the RAN may increase (e.g., due to an event, such as a sporting event, a concert, and/or the like). In some implementations, the ERAN may be enabled to handle the future state (e.g., to handle the additional load associated with the future state) even though the RAN is not disconnected from the core network. In this way, the ERAN may provide processing power to offload traffic associated with the future state.

As further shown in FIG. 1G, and by reference number 175, the ECORE may identify a future state of the RAN when connected to the core network, and may enable the ECORE based on the future state. For example, the ECORE may identify a future state where a load on the core network may increase (e.g., due to an event, such as a sporting event, a concert, and/or the like). In some implementations, the ECORE may be enabled to handle the future state (e.g., to handle the additional load associated with the future state) even though the RAN is not disconnected from the core network. In this way, the ECORE may provide processing power to offload traffic associated with the future state.

As shown in FIG. 1H, and by reference number 180, the ERAN may provide a federated ERAN via multiple ERANs. For example, the ERANs of multiple adjacent RANs may form a federated ERAN that allows synchronization and/or reconciliation between separate ERANs. The ERANs may utilize a distributed protocol (e.g., a block chain) for the synchronization and/or the reconciliation. In some implementations, each of the ERANs may be associated with a location area and/or a tracking area. In some implementations, access to the federated ERAN may be managed by security procedures, and classes of communications and/or messages may be delivered solely by the federated ERAN using the security procedures.

As further shown in FIG. 1H, and by reference number 185, the ECORE may provide a federated ECORE via multiple ECOREs. For example, the ECOREs of multiple adjacent RANs may form a federated ECORE that allows synchronization and/or reconciliation between separate ECOREs. The ECOREs may utilize a distributed protocol (e.g., a block chain) for the synchronization and/or the reconciliation. In some implementations, each of the ECOREs may be associated with a location area and/or a tracking area. In some implementations, access to the federated ECORE may be managed by security procedures, and classes of communications and/or messages may be delivered solely by the federated ECORE using the security procedures.

In this way, local radio network operations are sustained during isolation from a core network. For example, a RAN may be equipped with a local edge computing device that provides RAN services at the RAN. The edge computing device may perform a distribution unit (DU) function and a control unit (CU) function on a contingency basis. The RAN may also be equipped with a local edge computing device that provides network core services on a contingency basis at the RAN in conjunction with the local edge computing device that provides RAN services. Thus, the RAN conserves computing resources, networking resources, and/or the like that would otherwise have been lost by failing to provide core network services, failing to maintain continuity of service, losing management functions that lead to inefficiencies and issues in network performance, failing to maintain connectivity with adjacent RANs, handling security vulnerabilities, and/or the like.

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

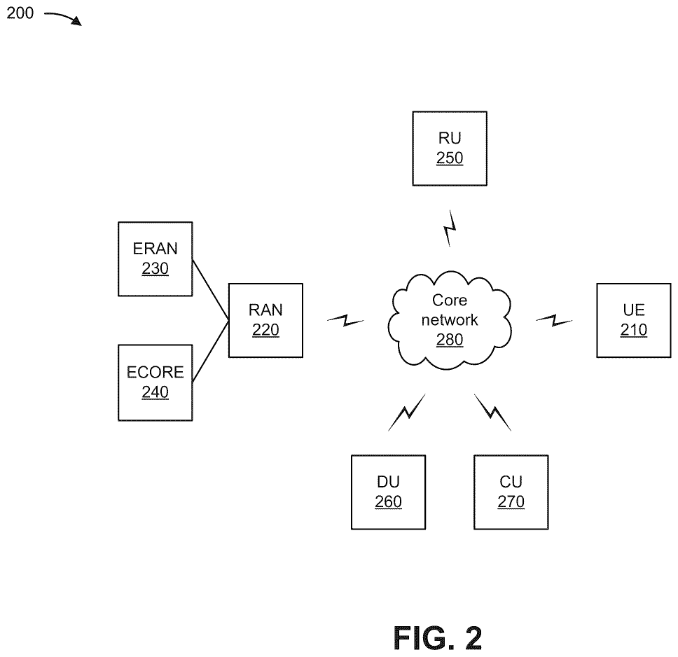

FIG. 2 is a diagram of an example environment 200 in which systems and/or methods described herein may be implemented. As shown in FIG. 2, the environment 200 may include a UE 210, a RAN 220, an ERAN 230, an ECORE 240, an RU 250, a DU 260, a CU 270, and/or a core network 280. Devices and/or elements of the environment 200 may interconnect via wired connections and/or wireless connections.

The UE 210 includes one or more devices capable of receiving, generating, storing, processing, and/or providing information, such as information described herein. For example, the UE 210 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 220 may support, for example, a cellular radio access technology (RAT). The RAN 220 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 210. The RAN 220 may transfer traffic between the UE 210 (e.g., using a cellular RAT), one or more base stations (e.g., using a wireless interface or a backhaul interface, such as a wired backhaul interface), and/or the core network 280. The RAN 220 may provide one or more cells that cover geographic areas.

In some implementations, the RAN 220 may perform scheduling and/or resource management for the UE 210 covered by the RAN 220 (e.g., the UE 210 covered by a cell provided by the RAN 220). In some implementations, the RAN 220 may be controlled or coordinated by a network controller, which may perform load balancing, network-level configuration, and/or other operations. The network controller may communicate with the RAN 220 via a wireless or wireline backhaul. In some implementations, the RAN 220 may include a network controller, a self-organizing network (SON) module or component, or a similar module or component. In other words, the RAN 220 may perform network control, scheduling, and/or network management functions (e.g., for uplink, downlink, and/or sidelink communications of the UE 210 covered by the RAN 220).

The ERAN 230 may include one or more devices capable of receiving, generating, storing, processing, providing, and/or routing information, as described elsewhere herein. The ERAN 230 may include a communication device and/or a computing device. For example, the ERAN 230 may include a server, such as an application server, a client server, a web server, a database server, a host server, a proxy server, a virtual server (e.g., executing on computing hardware), or a server in a cloud computing system. In some implementations, the ERAN 230 may include computing hardware used in a cloud computing environment, such as one or more serverless components (e.g., one or more serverless functions).

The ECORE 240 may include one or more devices capable of receiving, generating, storing, processing, providing, and/or routing information, as described elsewhere herein. The ECORE 240 may include a communication device and/or a computing device. For example, the ECORE 240 may include a server, such as an application server, a client server, a web server, a database server, a host server, a proxy server, a virtual server (e.g., executing on computing hardware), or a server in a cloud computing system. In some implementations, the ECORE 240 may include computing hardware used in a cloud computing environment, such as one or more serverless components (e.g., one or more serverless functions).

In some implementations, the RAN 220 may be implemented as a disaggregated base station. A disaggregated base station may include one or more units, such as one or more radio units (RUs) 250, one or more distributed units (DUs) 260, one or more centralized units (CUs) 270, or a combination thereof. A disaggregated base station may be configured to utilize a protocol stack that is physically or logically distributed among two or more units (such as one or more CUs 270, one or more DUs 260, or one or more RUs 250). In some implementations, a CU 270 may be implemented within the RAN 220, and one or more DUs 260 may be co-located with the CU 270, or alternatively, may be geographically or virtually distributed throughout one or multiple other RANs 220. The DUs 260 may be implemented to communicate with one or more RUs 250. Each of the RU 250, DU 260, and CU 270 also may be implemented as virtual units (e.g., a virtual radio unit (VRU), a virtual distributed unit (VDU), or a virtual centralized unit (VCU)). Disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

The RU 250 may include one or more devices capable of receiving, generating, storing, processing, providing, and/or routing information, as described elsewhere herein. The RU 250 may handle radio frequency (RF) processing, including the transmission and reception of radio signals to and from UEs 210. The RU 250 may include antennas, amplifiers, and other RF components. The RU 250 may perform functions such as signal modulation, demodulation, and filtering, and may convert the RF signals to digital signals for further processing by the DU 260.

The DU 260 may include one or more devices capable of receiving, generating, storing, processing, providing, and/or routing information, as described elsewhere herein. The DU 260 may perform real-time baseband processing tasks, including scheduling, resource allocation, and some radio link control functions. The DU 260 may serve as an intermediary between the RU 250 and the CU 270, handling the digital processing of signals received from the RU 250 before sending them to the CU 270 for higher-layer processing. The DU 260 may be located closer to the RU 250 to reduce latency and improve response times for time-sensitive operations.

The CU 270 may include one or more devices capable of receiving, generating, storing, processing, providing, and/or routing information, as described elsewhere herein. The CU 270 may be responsible for higher-layer protocol processing in the RAN 220. The CU 270 may handle functions such as packet routing, mobility management, and security. The CU 270 may manage the overall coordination and control of multiple DUs 260 and RUs 250 within its coverage area. By centralizing these functions, the CU 270 may optimize network resources and improve efficiency. The CU 270 may enable more flexible and scalable network deployment, as the CU 270 may be implemented in a centralized data center or cloud environment.

In some implementations, the core network 280 may include an example functional architecture in which systems and/or methods described herein may be implemented. For example, the core network 280 may include an example architecture of a fifth generation (5G) next generation (NG) core network included in a 5G wireless telecommunications system, a sixth generation (6G) core network included in a 6G wireless telecommunications system, and/or the like. While the example architecture of the core network 280 shown in FIG. 2 may be an example of a service-based architecture, in some implementations, the core network 280 may be implemented as a reference-point architecture and/or a fourth generation (4G) core network, among other examples.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

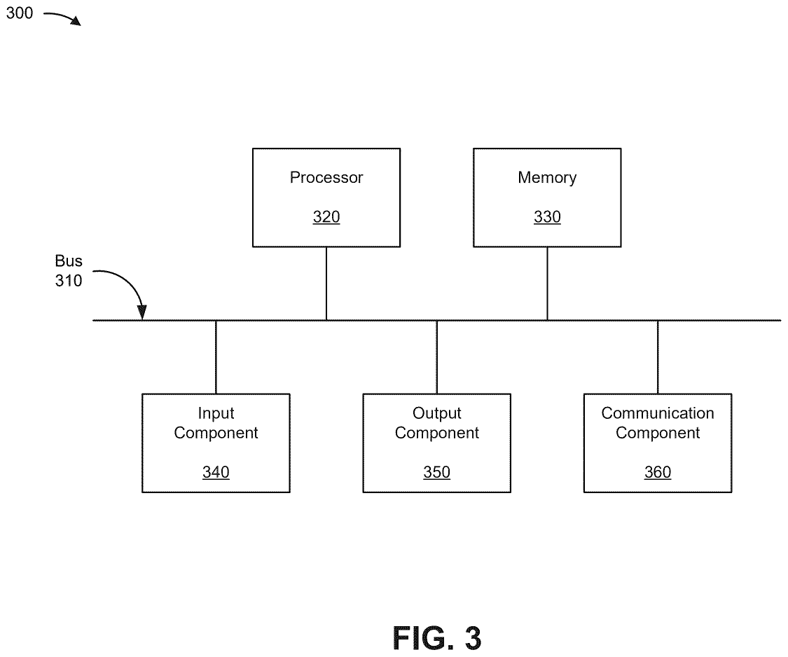

FIG. 3 is a diagram of example components of a device 300, which may correspond to the UE 210, the RAN 220, the ERAN 230, the ECORE 240, the RU 250, the DU 260, and/or the CU 270. In some implementations, the UE 210, the RAN 220, the ERAN 230, the ECORE 240, the RU 250, the DU 260, and/or the CU 270 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

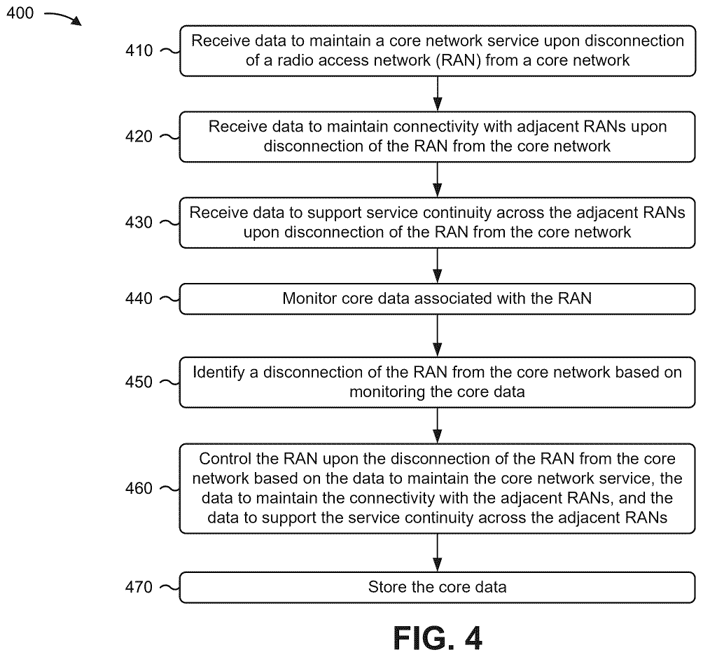

FIG. 4 is a flowchart of an example process 400 for sustaining local radio network operations during isolation from a core network s. In some implementations, one or more process blocks of FIG. 4 may be performed by a device (e.g., the ERAN 230 and/or the ECORE 240). In some implementations, one or more process blocks of FIG. 4 may be performed by another device or a group of devices separate from or including the device, such as an RU (e.g., the RU 250), a DU (e.g., the DU 260), and/or a CU (e.g., the CU 270). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving data to maintain a core network service upon disconnection of a RAN from a core network (block 410). For example, the device may receive data to maintain a core network service upon disconnection of a RAN from a core network, as described above. In some implementations, the device is an edge computing device.

As further shown in FIG. 4, process 400 may include receiving data to maintain connectivity with adjacent RANs upon disconnection of the RAN from the core network (block 420). For example, the device may receive data to maintain connectivity with adjacent RANs upon disconnection of the RAN from the core network, as described above.

As further shown in FIG. 4, process 400 may include receiving data to support service continuity across the adjacent RANs upon disconnection of the RAN from the core network (block 430). For example, the device may receive data to support service continuity across the adjacent RANs upon disconnection of the RAN from the core network, as described above.

As further shown in FIG. 4, process 400 may include monitoring core data associated with the RAN (block 440). For example, the device may monitor core data associated with the RAN, as described above.

As further shown in FIG. 4, process 400 may include identifying a disconnection of the RAN from the core network based on monitoring the core data (block 450). For example, the device may identify a disconnection of the RAN from the core network based on monitoring the core data, as described above.

As further shown in FIG. 4, process 400 may include controlling the RAN upon the disconnection of the RAN from the core network based on the data to maintain the core network service, the data to maintain the connectivity with the adjacent RANs, and the data to support the service continuity across the adjacent RANs (block 460). For example, the device may control the RAN upon the disconnection of the RAN from the core network based on the data to maintain the core network service, the data to maintain the connectivity with the adjacent RANs, and the data to support the service continuity across the adjacent RANs, as described above.

As further shown in FIG. 4, process 400 may include storing the core data (block 470). For example, the device may store the core data, as described above.

In some implementations, process 400 includes exchanging UE data with another device associated with an adjacent RAN. In some implementations, process 400 includes enabling a new UE via an existing UE of the RAN. In some implementations, process 400 includes receiving records from an HLR, and storing the records in an NLR. In some implementations, process 400 includes maintaining the records stored in the NLR during the disconnection of the RAN from the core network. In some implementations, process 400 includes enabling a new UE with the device via a secure credential container and the NLR.

In some implementations, process 400 includes providing the stored core data to the core network when a connection between the RAN and the core network is restored. In some implementations, process 400 includes identifying a future state of the RAN when connected to the core network, and enabling the device based on the future state. In some implementations, process 400 includes providing a federated device via multiple other devices associated with the adjacent RANs.

In some implementations, process 400 includes receiving data to maintain the RAN upon the disconnection of the RAN from the core network, monitoring RAN data associated with the RAN, and identifying the disconnection of the RAN from the core network based on monitoring the RAN data. In some implementations, process 400 includes maintaining connections within the RAN or with the adjacent RANs upon the disconnection of the RAN from the core network, and storing the RAN data. In some implementations, process 400 includes providing the stored RAN data to the RAN when a connection between the RAN and the core network is restored.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, and/or the like, depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, data to maintain a core network service upon disconnection of a radio access network (RAN) from a core network;
receiving, by the device, data to maintain connectivity with adjacent RANs upon disconnection of the RAN from the core network;
receiving, by the device, data to support service continuity across the adjacent RANs upon disconnection of the RAN from the core network;
monitoring, by the device, core data associated with the RAN;
identifying, by the device, a disconnection of the RAN from the core network based on monitoring the core data;
controlling, by the device, the RAN upon the disconnection of the RAN from the core network based on the data to maintain the core network service, the data to maintain the connectivity with the adjacent RANs, and the data to support the service continuity across the adjacent RANs; and
storing, by the device, the core data.

2. The method of claim 1, further comprising:
exchanging user equipment data with another device associated with an adjacent RAN.

3. The method of claim 1, further comprising:
enabling a new user equipment (UE) via an existing UE of the RAN.

4. The method of claim 1, further comprising:
receiving records from a home location register (HLR); and
storing the records in a neighborhood location register (NLR).

5. The method of claim 4, further comprising:
maintaining the records stored in the NLR during the disconnection of the RAN from the core network.

6. The method of claim 4, further comprising:
enabling a new user equipment with the device via a secure credential container and the NLR.

7. The method of claim 1, further comprising:
providing the stored core data to the core network when a connection between the RAN and the core network is restored.

8. A device, comprising:
one or more memories; and
one or more processors, coupled to the one or more memories, configured to:
receive data to maintain a core network service upon disconnection of a radio access network (RAN) from a core network;
receive data to maintain connectivity with adjacent RANs upon disconnection of the RAN from the core network;
receive data to support service continuity across the adjacent RANs upon disconnection of the RAN from the core network;
monitor core data associated with the RAN;
identify a disconnection of the RAN from the core network based on monitoring the core data;
control the RAN upon the disconnection of the RAN from the core network based on the data to maintain the core network service, the data to maintain the connectivity with the adjacent RANs, and the data to support the service continuity across the adjacent RANs;
store the core data; and
provide the stored core data to the core network when a connection between the RAN the core network is restored.

9. The device of claim 8, wherein the one or more processors are further configured to:
identify a future state of the RAN when connected to the core network, and
enable the device based on the future state.

10. The device of claim 8, wherein the one or more processors are further configured to:
provide a federated device via multiple other devices associated with the adjacent RANs.

11. The device of claim 8, wherein the one or more processors are further configured to:
receive data to maintain the RAN upon the disconnection of the RAN from the core network;
monitor RAN data associated with the RAN; and
identify the disconnection of the RAN from the core network based on monitoring the RAN data.

12. The device of claim 11, wherein the one or more processors are further configured to:
maintain connections within the RAN or with the adjacent RANs upon the disconnection of the RAN from the core network; and
store the RAN data.

13. The device of claim 12, wherein the one or more processors are further configured to:
provide the stored RAN data to the RAN when a connection between the RAN the core network is restored.

14. The device of claim 8, wherein the device is an edge computing device.

15. A non-transitory computer-readable medium storing a set of instructions, the set of instructions comprising:
one or more instructions that, when executed by one or more processors of a device, cause the device to:
receive data to maintain a core network service upon disconnection of a radio access network (RAN) from a core network;
receive data to maintain connectivity with adjacent RANs upon disconnection of the RAN from the core network;
receive data to support service continuity across the adjacent RANs upon disconnection of the RAN from the core network;
monitor core data associated with the RAN;
identify a disconnection of the RAN from the core network based on monitoring the core data;
control the RAN upon the disconnection of the RAN from the core network based on the data to maintain the core network service, the data to maintain the connectivity with the adjacent RANs, and the data to support the service continuity across the adjacent RANs;
store the core data; and
exchange user equipment data with another device associated with an adjacent RAN.

16. The non-transitory computer-readable medium of claim 15, wherein the one or more instructions further cause the device to:
enable a new user equipment (UE) via an existing UE of the RAN.

17. The non-transitory computer-readable medium of claim 15, wherein the one or more instructions further cause the device to:
receive records from a home location register (HLR);
store the records in a neighborhood location register (NLR);
maintain the records stored in the NLR during the disconnection of the RAN from the core network; and
enable a new user equipment with the device via a secure credential container and the NLR.

18. The non-transitory computer-readable medium of claim 15, wherein the one or more instructions further cause the device to:
provide the stored core data to the core network when a connection between the RAN the core network is restored.

19. The non-transitory computer-readable medium of claim 15, wherein the one or more instructions further cause the device to:
identify a future state of the RAN when connected to the core network, and
enable the device based on the future state.

20. The non-transitory computer-readable medium of claim 15, wherein the one or more instructions further cause the device to:
provide a federated device via multiple other devices associated with the adjacent RANs.
